(19) United States
(12) Patent Application Publication
(10) Pub. No.: US 2009/0113063 A1
(43) Pub. Date: Apr. 30, 2009

(54) AUTHENTICATION METHOD AND APPARATUS FOR INTEGRATING TICKET-GRANTING SERVICE INTO SESSION INITIATION PROTOCOL

(75) Inventor: Ming-Fong Yeh, Taiwan (CN)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/294,343

(22) PCT Filed: Jun. 13, 2007
(86) PCT No.: PCT/JP2007/062369

§ 371 Date: Sep. 24, 2008

(30) Foreign Application Priority Data
Jun. 15, 2006 (CN) 200610092528.1

(51) Int. Cl. G06F 15/16

(52) U.S. Cl. 709/229

(57) ABSTRACT

In an authentication method for integrating ticket-granting service into session initiation protocol, a server provides session initiation protocol and ticket-granting services between a calling facility and a called facility, and the method includes enabling the calling facility to obtain a first ticket from the server, and subsequently issue an INVITE message containing the first ticket attached thereto to the server. If the server verifies that the first ticket be issued by the server itself, the server examines the registration status of the called facility in the server. If the status of the called facility is registered, identity authentication of the calling facility and called facility proceeds according to a predetermined ticket authentication procedure. If the authentication is successful, the called facility can establish a communication session with the calling facility.

### TECHNICAL FIELD

The invention relates to a method and apparatus for signaling transmission, and more particularly to an authentication method and apparatus for integrating ticket-granting service (TGS) into Session Initiation Protocol (SIP).

### BACKGROUND ART

The so-called telephone exchange techniques can be briefly explained by way of a signaling exchange system. A conventional exchange system employs many interconnected physical switches to achieve the objective of interconnecting telephone devices. Compared with the disadvantages of connection complexities and expensive call fees inherent in conventional exchange systems, transmission of digital voice packets over the network, i.e., Voice over Internet Protocol (VoIP), has become popular with the more sophisticated development of network communication technology in recent years. At present, signaling protocols that are commonly used on the network include standards like SIP.

Referring to FIG. 1, in the SIP standard, a session invitation is an INVITE message that is sent to a SIP server 82 by a caller 81 so as to establish a communication session with a callee 83. The SIP server 82 can provide functions like routing session invitations, performing identity authentication and account management, etc. Therefore, the SIP server 82 can find the location of the callee 83 and forward the INVITE message to the callee 83. When the phone of the callee 83 starts to ring, the callee 83 sends 180 Ringing messages to notify the caller 81 through the SIP server 82. If the callee 83 picks up the phone, a 200 OK message will be sent to the caller 81 through the SIP server 82. When the callee 83 receives an ACK message from the caller 81, a communication tunnel between the caller 81 and the callee 83 is established.

In addition, because the Internet is an open system, its security is less strong than that of closed traditional exchange systems. Besides, it also requires verification of user's identity to facilitate fee calculation when call service is used. Thus, authentication mechanisms with security have been developed. For example, the Massachusetts Institute of Technology (MIT) of the United States has proposed an authentication mechanism: Kerberos.

Referring to FIG. 2, according to the authentication process in Kerberos authentication mechanism, a caller 91 establishes a secure session tunnel with a callee 93 through authentication service provided by a key distribution center (KDC) 92. The key distribution center 92 can provide users with login authentication service (AS) and ticket-granting service (TGS).

The principle behind ticket-granting service is that tickets provided can be used only between the user (client) and the key distribution center 92. A ticket includes information, such as the user's ID, IP address, timestamp (current time), etc. The ticket is sent to the key distribution center 92 only when the user contacts the key distribution center 92. Therefore, the ticket-granting service can enhance the security of data transmission and can prevent theft of personal information contained therein.

According to Kerberos authentication mechanism, the caller 91 first performs a login procedure, and sends a message 901 containing an identity identification code “A” thereof to the key distribution center 92. Thereafter, the authentication service of the key distribution center 92 sends to the caller 91 a message 902: a message containing (session key K_{S}, ticket K_{TGS}(A, K_{S})) and encrypted with a caller key K_{A}. The caller key K_{A} is a password of the caller 91. The session key K_{S} is used only by the caller 91 and the key distribution center 92, whereas the ticket K_{TGS}(A, K_{S}) is to be used when the caller 91 requests further services.

When the caller 91 receives the message 902 and decrypts the message 902 using the caller key K_{A} to obtain the session key K_{S} and the ticket K_{TGS}(A, K_{S}), this indicates a successful login procedure. Due to use of the session key K_{S} and the ticket K_{TGS}(A, K_{S}), contents of communicated data can be protected against hackers for subsequent communication services.

The caller 91 sends a message 903 when the caller 91 intends to request communication service with the callee 93. The message 903 includes the ticket K_{TGS}(A, K_{S}) and a ticket-granting request K_{S}(t,B), in which a first timestamp “t” represents the time when the call session is initiated, and the ticket-granting request K_{S}(t,B) is used to request the ticket-granting service of the key distribution center 92 to provide a ticket-granting service for an identity with identification code “B.” The ticket-granting request K_{S}(t,B) is generated only when ticket-granting service is requested, and will be deleted after authentication.

At this time, the ticket-granting service (TGS) of the key distribution center 92 will send the caller 91 a message 904: a message containing (identification code “B” and communication key “K_{AB}”) encrypted with the session key K_{S} and (identification code “A” and communication key “K_{AB}”) encrypted with a callee key K_{B}. Issued with the communication key K_{AB}, the caller 91 is allowed to communicate securely with the callee 93 in the subsequent process.

Accordingly, the caller 91 sends the callee 93 a message 905 containing identification code “A” and communication key “K_{AB}” encrypted with key K_{B}, i.e., K_{B}(A, K_{AB}), and the first timestamp “t” encrypted with the key K_{AB}, i.e., K_{AB}(t). The callee 93 decrypts the message 905 with the key K_{B} thereof, and encrypts a second timestamp “t+1” with the key K_{AB}, which is sent to the caller 91 in a message 907, so that the caller 91 can confirm that the other party is the callee 93 and a communication session can begin.

Although current SIP standard (RFC 3261—SIP: Session Initiation Protocol) provides an authentication mechanism, the authentication mechanism merely provides one-way challenge-response authentication, i.e., authentication between caller and proxy server. There is not a two-way or mutual secure authentication service, i.e., authentication between caller and callee. US Patent Application Publication No. US 20030005280 proposes a mutual secure authentication service based on the SIP standard and integrating the Kerberos authentication mechanism. However, the transmission of additional messages (among caller, proxy server and callee) is necessary in the process of establishing a communication session according to said patent. This is likely to result in a noticeable delay of the entire session establishing process.

### DISCLOSURE OF INVENTION

The concept of the present invention is to provide mutual security authentication based on ticket-granting service, and to simplify the process steps of the prior art, so as to avoid the delay caused by the transmission of additional messages during the process of establishing a session, and so as to avoid the waste of system resources caused by discovering a failure of communication with a called facility after performing a series of authentication steps.

Therefore, the first object of the present invention is to provide an authentication method based on session initiation protocol (SIP) integrated with ticket-granting service (TGS), which permits mutual security authentication and which can avoid the waste of system resources.

Accordingly, the authentication method for integrating ticket-granting service into session initiation protocol of the present invention is to provide session initiation protocol and ticket-granting services between a calling facility and a called facility through a server. The authentication method includes the following steps:

(A) enabling the calling facility to obtain a first ticket from the server;

(B) enabling the calling facility to issue an INVITE message with the first ticket attached thereto to the server;

(C) enabling the server to examine the registration status of the called facility in the server if the server verifies that the first ticket be issued by the server itself, the flow proceeding to step (D) if the status of the called facility is registered, otherwise the server not providing subsequent ticket-granting service; and

(D) performing identity authentication of both the calling facility and the called facility according to a predetermined ticket authentication procedure so that, if the authentication is successful, the called facility can establish a communication session with the calling facility.

The second object of the present invention is to provide a server for executing a method of integrating ticket-granting service into session initiation protocol, and for providing mutual security authentication and avoiding the waste of system resources. The server of the present invention is used to provide session initiation protocol and ticket-granting services between a calling facility and a called facility. The server includes a server database, a control module, a ticket-granting service module, a session initiation protocol unit, and a communication interface.

The server database stores registration data of users and a first ticket issued to the calling facility beforehand. The control module is used to coordinate the operations of various units, and has an examining unit and a determining unit. The examining unit is used to perform relevant examination tasks with respect to received messages. The determining unit is used to determine the registration status of the called facility.

The ticket-granting service module is used to provide ticket-granting service and to perform relevant ticket processing tasks. The session initiation protocol unit is used to provide session initiation protocol service, and cooperates with the ticket-granting service module to process data into messages with formats complying with the session initiation protocol. The communication interface acts as an interface to communicate with other devices, and is used to transmit messages processed by the session initiation protocol unit to the other devices and to receive outside messages.

Thus, when the communication interface receives an outside message, the examining unit of the control module examines the received message. If the examining unit verifies that the outside message has the first ticket stored in the server database attached thereto, the determining unit determines the registration status of the called facility in the server database. If the status of the called facility is registered, the ticket-granting service module provides subsequent ticket-granting service. If the status of the called facility is not registered, the ticket-granting service module does not provide subsequent ticket-granting service.

The third object of the present invention is to provide a calling facility for executing a method of integrating ticket-granting service into session initiation protocol, and for providing mutual security authentication and avoiding the waste of system resources.

The calling facility of the present invention is used to receive session initiation protocol and ticket-granting services provided by a server. The server has issued a first ticket to the calling facility. The calling facility includes a user interface, a client database, a control module, a ticket-granting service module, a session initiation protocol unit, and a communication interface.

The user interface is for input of data by the user. The client database is used to store the first ticket and a caller key of the calling facility. The control module is used to coordinate the operations of various units. The ticket-granting service module is used to provide the ticket-granting service and to perform relevant ticket processing tasks. The session initiation protocol unit is used to provide session initiation protocol service, and cooperates with the ticket-granting service module to process data into messages with formats complying with the session initiation protocol. The communication interface acts as an interface to communicate with other devices, and is used to transmit messages processed by the session initiation protocol unit to the other devices and to receive outside messages.

Thus, if the calling facility intends to establish a communication session with a called facility, the user interface receives data of the called facility inputted from the outside, and the ticket-granting service module retrieves the first ticket from the client database. The session initiation protocol unit cooperates with the ticket-granting service module to process the data into an INVITE message having the first ticket attached thereto and has the INVITE message transmitted to the server via the communication interface.

The fourth object of the present invention is to provide a called facility for executing a method of integrating ticket-granting service into session initiation protocol, and for providing mutual security authentication and avoiding the waste of system resources.

The called facility of the present invention is used to receive session initiation protocol and ticket-granting services provided by a server so as to establish a communication session with a calling facility. The called facility includes a user interface, a client database, a control module, a ticket-granting service module, a session initiation protocol unit, and a communication interface.

The user interface is for input of data by the user. The client database is used to store a callee key of the called facility. The control module is used to coordinate the operations of various units. The ticket-granting service module is used to provide the ticket-granting service and to perform relevant ticket processing tasks. The ticket-granting service module includes an identifying unit for identifying received tickets. The session initiation protocol unit is used to provide session initiation protocol service and cooperates with the ticket-granting service module to process data into messages with formats complying with the session initiation protocol. The communication interface acts as an interface to communicate with other devices, and is used to transmit messages processed by the session initiation protocol unit to the other devices and to receive outside messages.

Thus, when the called facility receives an outside message via the communication interface, an examining unit of the control module is responsible for examining whether the message contains a second ticket and a third ticket generated by the server. If the second and third tickets are available, the ticket-granting service module provides ticket-granting service and performs the relevant ticket processing tasks. Otherwise, the ticket-granting service module does not provide subsequent ticket-granting service.

### BRIEF DESCRIPTION OF DRAWINGS

Other features and advantages of the present invention will become apparent in the following detailed description of the preferred embodiment with reference to the accompanying drawings, of which:

FIG. 1 is a diagram to illustrate the flow of messages when a caller sends an INVITE message to a SIP server for establishing a communication session with a callee according to the session initiation protocol standard;

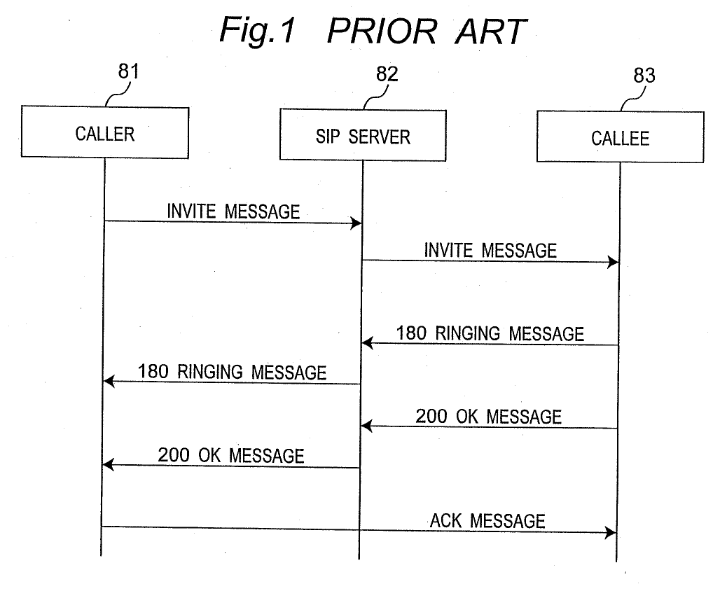

FIG. 2 is a message flow diagram to illustrate the authentication process of a current Kerberos authentication mechanism, in which a caller establishes a communication tunnel with a callee using authentication service provided by a key distribution center;

FIG. 3 is a message flow diagram to illustrate the preferred embodiment of an authentication method for integrating ticket-granting service into session initiation protocol, the preferred embodiment being applied to a signaling system, which includes a calling facility, a SIP server, and a called facility;

FIG. 4 is a system block diagram to illustrate the calling facility and called facility of the preferred embodiment;

FIG. 5 is a system block diagram to illustrate the SIP server of the preferred embodiment;

FIG. 6 is an operational flowchart of the calling facility of the preferred embodiment;

FIG. 7 is an operational flowchart of the SIP server of the preferred embodiment; and

FIG. 8 is an operational flowchart of the called facility of the preferred embodiment.

### BEST MODE FOR CARRYING OUT THE INVENTION

Before the present invention is described in greater detail with reference to the accompanying preferred embodiment, it should be noted that, while the ticket-granting service referred to in the preferred embodiment is generated according to Kerberos authentication mechanism, other ticket authentication mechanisms similar to Kerberos authentication mechanism are also applicable to use in the present invention.

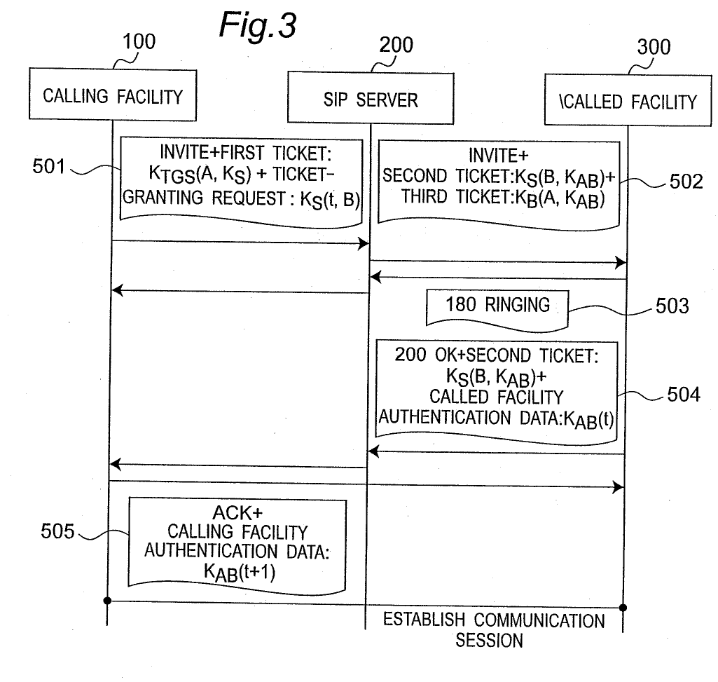

Referring to FIG. 3, the preferred embodiment of an authentication method for integrating ticket-granting service into the session initiation protocol according to the present invention is applied to a signaling system. The signaling system includes a calling facility 100, a SIP server 200, and a called facility 300.

In the preferred embodiment, session initiation protocol and ticket-granting services between the calling facility 100 and the called facility 300 are provided through the SIP server 200. The authentication method principally includes the following steps:

The calling facility 100 first obtains a first ticket from the SIP server 200. Subsequently, the calling facility 100 requests a communication session with the called facility 300 by sending an INVITE message 501 containing the first ticket and a ticket-granting request to the SIP server 200.

If the SIP server 200 verifies that the first ticket be issued by itself, the registration status of the called facility 300 in the SIP server 200 is examined. If the status of the called facility 300 is “not registered,” subsequent ticket-granting service will not be provided. If the status of the called facility 300 is “registered,” subsequent ticket-granting service will be provided: The SIP server 200 generates a second ticket for use by the calling facility 100, and a third ticket for use by the called facility 300 according to the ticket-granting request, attaches the second and third tickets to the INVITE message 502, and sends the INVITE message 502 to the called facility 300.

When the called facility 300 receives the INVITE message 502, the called facility 300 first generates “180 Ringing” (message 503) as response, and then generates a reply (OK) message 504 containing called facility authentication data, which is sent to the calling facility 100 through the SIP server 200.

Subsequently, the calling facility 100 generates an acknowledge (ACK) message 505 containing calling facility authentication data after identifying the called facility authentication data in message 504, and sends the ACK message 505 to the called facility 300. Finally, the called facility 300 identifies the calling facility authentication data in the ACK message 505, and then directly establishes a communication session with the calling facility 100.

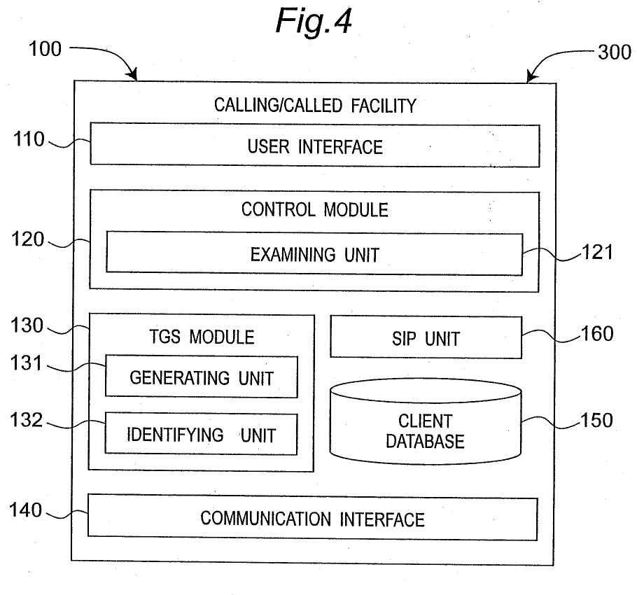

Referring to FIG. 4, the calling facility 100 and the called facility 300 have similar components, including a user interface 110, a control module 120, a ticket-granting service module (hereinafter referred to as TGS module) 130, a communication interface 140, a client database 150, and a session initiation protocol module (hereinafter referred to as SIP unit) 160.

The user interface 110 permits input of data by the user. The client database 150 is used to store relevant data, such as tickets and keys. The control module 120 is used to coordinate the operations of various components, and has an examining unit 121 for examining outside messages to see if they contain authentication data. The TGS module 130 is used to provide ticket-granting service and to perform relevant ticket processing tasks. The TGS module 130 has a generating unit 131 and an identifying unit 132. The generating unit 131 is used to automatically generate tickets. The identifying unit 132 is used to identify ticket contents (the purpose of which will be described hereinafter). The SIP unit 160 is used to provide session initiation protocol service, and cooperates with the TGS module 130 to process data into SIP-compliant messages. The communication interface 140 acts as an interface to communicate with other devices, and is used to transmit messages processed by the SIP unit 160 to the other devices and to receive outside messages.

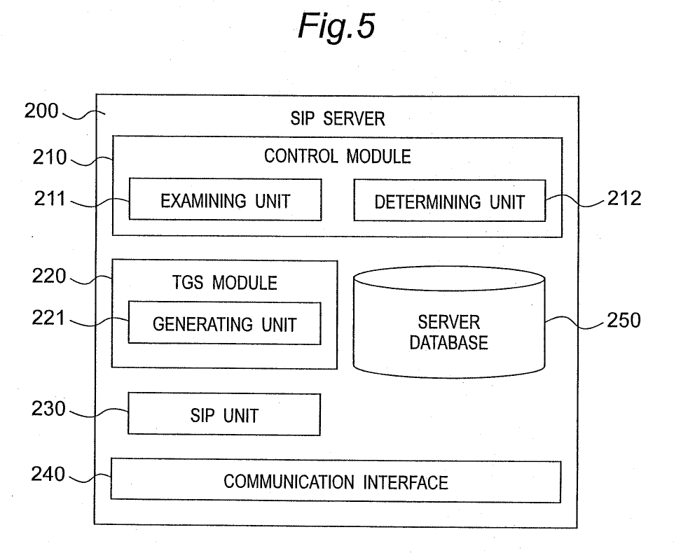

Referring to FIG. 5, the SIP server 200 includes a control module 210, a TGS module 220, a SIP unit 230, a communication interface 240, and a server database 250.

The control module 210 is used to coordinate the operations of various units, and includes an examining unit 211 and a determining unit 212. The examining unit 211 is used to perform examination tasks of authenticating received messages. The determining unit 212 is used to determine the registration status of the called facility 300. The TGS module 220 is used to provide ticket-granting service and to perform relevant ticket processing tasks. The TGS module 220 includes a generating unit 221, which is used to generate tickets. The communication interface 240 acts as an interface to communicate with other devices. The server database 250 is used to store relevant tickets. The SIP unit 230 is used to process SIP message-related processing tasks.

Referring to FIG. 3, in combination with FIGS. 4 and 5, the actual contents of messages 501˜505 generated when a session is initiated and the principle behind the generation of the messages 501˜505 in the preferred embodiment will be described hereinbelow. It is noted that, on the side of the calling facility 100, the user inputs an identity identification code “A” and a password thereof via the user interface 110 to log in, and has obtained a first ticket K_{TGS}(A,K_{S}) stored in the client database 150.

Message 501: When the calling facility 100 intends to establish a communication session with the remote called facility 300, an identity identification code “B” of the called facility 300 is inputted. Such input operation is also to notify the TGS module 130 of the calling facility 100 to prepare relevant information: the first ticket K_{TGS}(A,K_{S}) previously obtained from the SIP server 200 is retrieved from the client database 150, and a ticket-granting request K_{S}(t,B) is issued. The ticket-granting request K_{S}(t,B) is used to request the provision of a ticket-granting service for an identity with identification code “B”.

When the TGS module 130 of the calling facility 100 obtains the first ticket K_{TGS}(A,K_{S}) and the ticket-granting request K_{S}(t,B), the TGS module 130 will immediately notify the SIP unit 160 to embed the obtained first ticket K_{TGS}(A,K_{S}) and ticket-granting request K_{S}(t,B) as an additional message header in an INVITE message 501, and sends the INVITE message 501 to the SIP server 200 through the communication interface 140.

Message 502: When the SIP server 200 receives the INVITE message 501 through the communication interface 240 thereof, the examining unit 211 of the control module 210 examines whether the INVITE message 501 contains the previously issued first ticket K_{TGS}(A,K_{S}) and the ticket-granting request K_{S}(t,B). Subsequently, the determining unit 212 of the control module 210 inspects the registration status of the called facility 300 in the server database 250.

If the called facility 300 is not a registered user, subsequent ticket granting and authentication processing will not be provided. If the called facility 300 is a registered user, the generating unit 221 of the TGS module 220 of the SIP server 200 generates a second ticket K_{S}(B, K_{AB}) according to the first ticket K_{TGS}(A,K_{S}) and the identity identification code “B” of the called facility 300, and generates a third ticket K_{B}(A, K_{AB}) according to the first ticket K_{TGS}(A,K_{S}) and the identity identification code “A” of the calling facility 100. The second ticket K_{S}(B, K_{AB}) is for use by the calling facility 100, and the third ticket K_{B}(A, K_{AB}) is for use by the called facility 300.

Subsequently, the SIP unit 230 of the SIP server 200 attaches the second ticket K_{S}(B, K_{AB}) and the third ticket K_{B}(A, K_{AB}) to a payload of the INVITE message to create the message 502, and the communication interface 240 forwards the message 502 to the called facility 300.

Message 503: On the side of the called facility 300, the INVITE message 502 can be received from the SIP server 200 through the communication interface 140 of the called facility 300. At this time, the control module 120 will notify the SIP unit 160 of the called facility 300 to send “180 Ringing” messages to the calling facility 100.

Message 504: When the SIP unit 160 of the called facility 300 sends the “180 Ringing” message, it also notifies the examining unit 121 of the called facility 300 to examine whether the INVITE message contains the second ticket K_{S}(B, K_{AB}) and the third ticket K_{B}(A, K_{AB}). If the two tickets are available, the second ticket K_{S}(B, K_{AB}) is stored in the client database 150 of the called facility 300, and the third ticket K_{B}(A, K_{AB}) is decrypted with the key K_{B} of the called facility 300 so as to obtain the identity identification code “A” of the calling facility 100 and the communication key K_{AB} that only the calling facility 100 and the called facility 300 can use, and the generating unit 131 of the TGS module 130 generates called facility authentication data K_{AB}(t). The called facility authentication data K_{AB}(t) is generated primarily based on the aforementioned first timestamp “t” and the communication key K_{AB}. After generating the called facility authentication data K_{AB}(t), the SIP unit 160 of the called facility 300 constructs a payload containing the second ticket K_{S}(B, K_{AB}) and the called facility authentication data K_{AB}(t) in a “200 OK” reply message 504, and forwards the message 504 to the calling facility 100 through the SIP server 200 via the communication interface 140.

It is noted that the called facility authentication data K_{AB}(t) and the second ticket K_{S}(B, K_{AB}) may also be attached to the “180 Ringing” message 503.

Message 505: After the calling facility 100 receives the “200 OK” reply message 504 through the communication interface 140 thereof, it can notify the examining unit 121 thereof to examine whether the “200 OK” reply message 504 contains the called facility authentication data K_{AB}(t). Under the circumstance that all the data are available, the identifying unit 132 identifies whether the second ticket K_{S}(B, K_{AB}) and the first timestamp “t” are present, so as to verify that it is the request to initiate a communication session with the called facility 300 at calling time “t,” and so as to extract the communication key K_{AB} that only the calling facility 100 and the called facility 300 can use.

Subsequently, the generating unit 131 of the calling facility 100 generates a second timestamp “t+1” according to the received calling time “t,” generates calling facility authentication data K_{AB}(t+1) according to the communication key K_{AB}, and then notifies the SIP unit 160 to construct a payload containing the calling facility authentication data K_{AB}(t+1) in an acknowledge message 505 (hereinafter referred to as ACK message), and to send the “ACK” message 505 to the called facility 300 through the communication interface 140.

Establishing a communication session: After the called facility 300 receives the “ACK” message 505, it immediately notifies the examining unit 121 thereof to examine whether the “ACK” message 505 contains the calling facility authentication data K_{AB}(t+1), and notifies the identifying unit 132 if the calling facility authentication data K_{AB}(t+1) is present. The identifying unit 132 can then use the called facility authentication data K_{AB}(t) and the third ticket K_{B}(A, K_{AB}) stored in the client database 150 to identify the second timestamp “t+1” in the calling facility identification data K_{AB}(t+1). Thus, the calling facility 100 and the called facility 300 can start establishing a communication session.

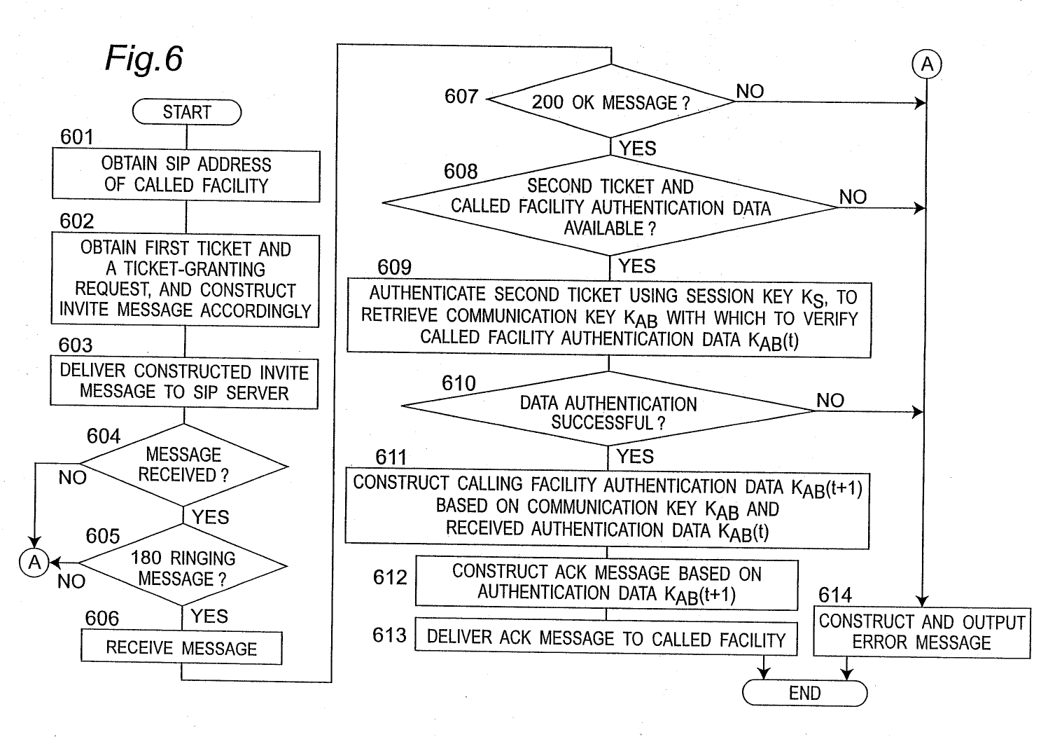

Referring to FIGS. 3 and 6, the operational flow of the preferred embodiment of the calling facility 100 according to the present invention is described as follows:

Initially, the identity identification code “B” of the callee is inputted into the calling facility 100 so as to obtain the pre-stored SIP address of the called facility 300 (step 601), the first ticket K_{TGS}(A,K_{S}) issued by the SIP server 200 beforehand is retrieved, and an INVITE message is constructed according to the first ticket K_{TGS}(A,K_{S}) and a ticket-granting request (step 602). Subsequently, after sending the constructed INVITE message to the SIP server 200 (step 603), it is determined whether a message is received (step 604). After receipt of the message, it is determined whether the message is a “180 Ringing” message (step 605). If it is a “180 Ringing” message, the “180 Ringing” message is received (step 606).

Thereafter, it is determined whether a “200 OK” message is present (step 607). In the affirmative, the message is examined to determine whether the second ticket K_{S}(B, K_{AB}) and the called facility authentication data K_{AB}(t) are available in the “200 OK” message (step 608). In the affirmative, the second ticket K_{S}(B, K_{AB}) is authenticated using the session key K_{S}, the communication key K_{AB} is extracted from the decrypted second ticket K_{S}(B, K_{AB}), and the called facility authentication data K_{AB}(t) is verified based on the extracted communication key K_{AB} (step 609). It is further determined whether verification of the authentication data is successful (step 610). If positive, calling facility authentication data K_{AB}(t+1) is constructed based on the communication key K_{AB} and the received called facility authentication data K_{AB}(t) (step 611). An ACK message is constructed based on the calling facility authentication data K_{AB}(t+1) (step 612). Finally, the ACK message is sent to the called facility 300 (step 613).

It is noted that, if an error occurs in any of the steps during the process flow, e.g., no message is received (in step 604, 605, 607, or 608) or authentication fails (step 610), an error message is constructed and outputted (step 614).

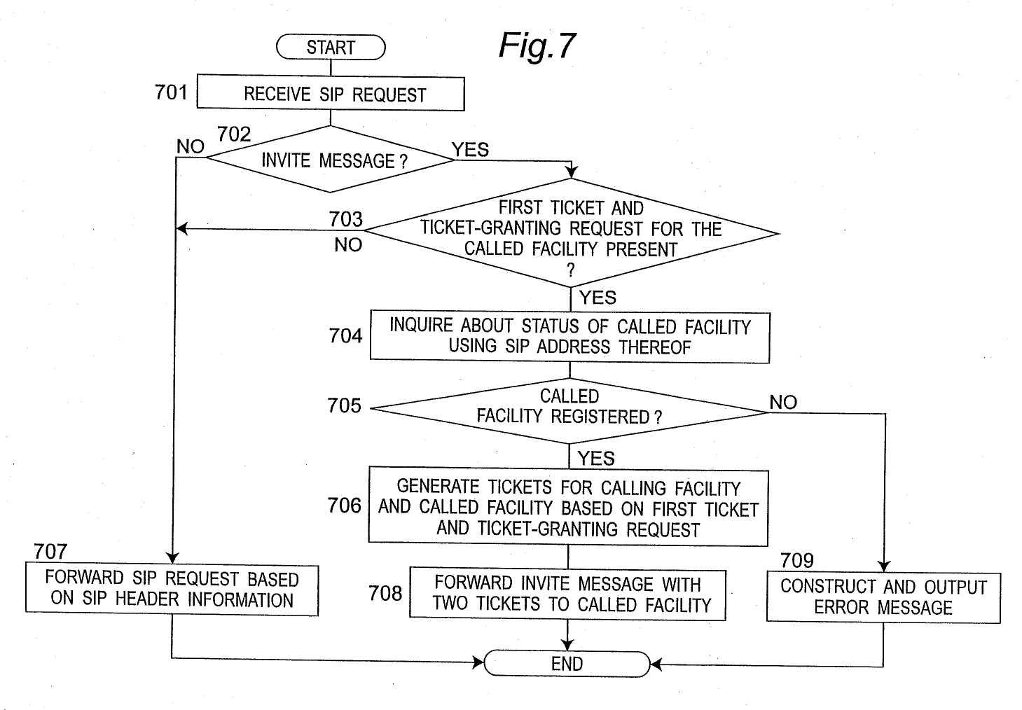

Referring to FIGS. 3 and 7, the operational flow of the preferred embodiment of the SIP server 200 according to the present invention is described as follows:

Initially, a SIP request is received from the calling facility 100 (step 701), and it is determined whether the SIP request is an “INVITE” message (step 702). If it is an “INVITE” message, it is determined whether the first ticket K_{TGS}(A,K_{S}) and a ticket-granting request for the called facility 300 is present in the “INVITE” message (step 703). In the affirmative, an inquiry is conducted on the status of the called facility 300 using the SIP address thereof (step 704). It is then determined whether the called facility 300 has been registered (step 705). In the affirmative, a second ticket K_{S}(B, K_{AB}) and a third ticket K_{B}(A, K_{AB}) are generated for the calling facility 100 and the called facility 300, respectively, based on the first ticket K_{TGS}(A,K_{S}) and the ticket-granting request (step 706). The “INVITE” message containing the second ticket K_{S}(B, K_{AB}) and the third ticket K_{B}(A, K_{AB}) is forwarded to the called facility 300 (step 708).

Supposing it is determined in step 702 that the SIP request is not an “INVITE” message, or supposing it is determined in step 703 that the first ticket K_{TGS}(A,K_{S}) is not present in the “INVITE” message, the SIP request is forwarded according to the SIP header information in the SIP request (step 707). In addition, if it is determined in step 705 that the called facility 300 is not registered, an error message is constructed and outputted (step 709).

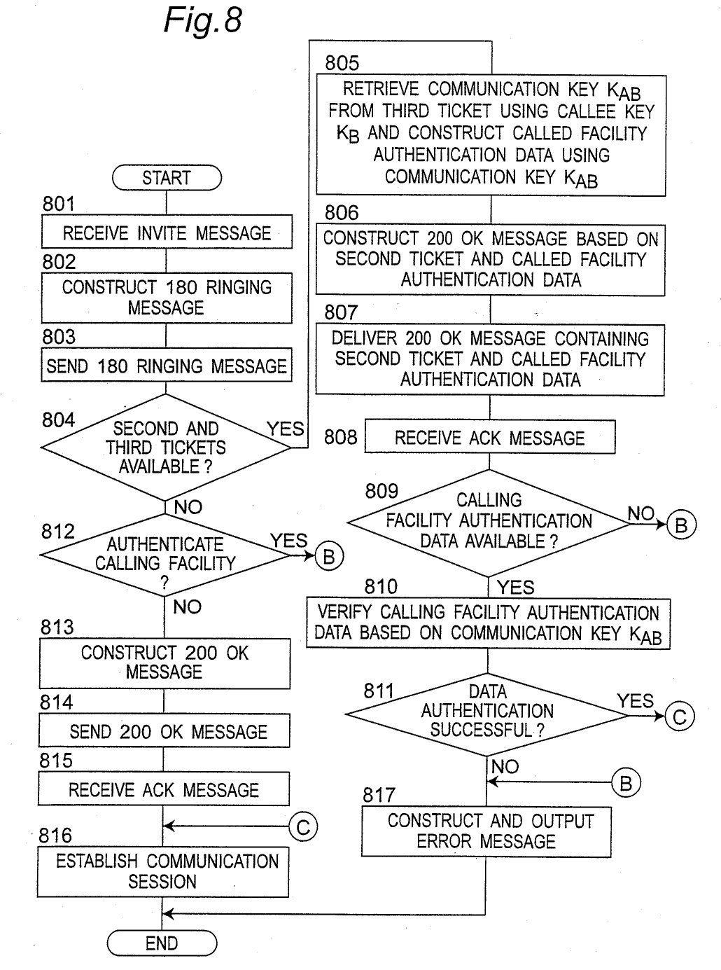

Referring to FIGS. 3 and 8, the operational flow of the preferred embodiment of the called facility 300 according to the present invention is described as follows:

Initially, an “INVITE” message is received (step 801). A “180 Ringing” response is constructed (step 802). The “180 Ringing” response is sent (step 803). It is examined whether the second and third tickets K_{S}(B, K_{AB}), K_{B}(A, K_{AB}) are present (step 804). If they are not present, it is determined whether authentication of the calling facility 100 is necessary (step 812). If negative, the conventional scheme is conducted: constructing a “200 OK” message (813); delivering the “200 OK” message (step 814); and then receiving an “ACK” message (815) so as to establish a communication session (step 816).

If it is determined in step 804 that the second and third tickets K_{S}(B, K_{AB}), K_{B}(A, K_{AB}) are present, verification of the third ticket K_{B}(A, K_{AB}) is conducted according to the key K_{B} of the called facility 300 so that the communication key K_{AB} is extracted from the decrypted third ticket K_{B}(A, K_{AB}) to create the called facility authentication data K_{AB}(t) (step 805); a “200 OK” message is constructed according to the second ticket K_{S}(B, K_{AB}) and the called facility authentication data K_{AB}(t) (step 806); and the “200 OK” message containing the second ticket K_{S}(B, K_{AB}) and the called facility authentication data K_{AB}(t) is delivered (step 807).

Subsequently, an “ACK” message is received (step 808). It is determined whether the calling facility authentication data K_{AB}(t+1) is present in the “ACK” message (step 809). In the affirmative, the calling facility authentication data K_{AB}(t+1) is verified according to the communication key K_{AB} (step 810). Thereafter, it is determined whether verification of the calling facility authentication data K_{AB}(t+1) is successful (step 811). Supposing the data verification in step 811 fails, an error message is constructed and outputted (step 817). Supposing the data verification in step 811 is successful, a communication session is established (step 816).

In view of the foregoing, the major differences between the authentication method of integrating ticket-granting service into session initiation protocol according to the present invention and the conventional SIP standard technique can be summarized as follows:

1. The SIP server 200 of the present invention can provide both session initiation protocol and ticket-granting service mechanisms, so that the user does not have to submit session initiation protocol and ticket-granting service requests to different servers.

2. After receiving an INVITE message from the calling facility 100, the SIP server 200 will first determine the registration status of the called facility 300. Supposing the called facility 300 is not registered with the SIP server 200, the SIP server 200 will directly respond to the calling facility 100 with an error message, without proceeding with the subsequent authentication actions in messages 503˜506, thereby avoiding the waste of relevant system resources.

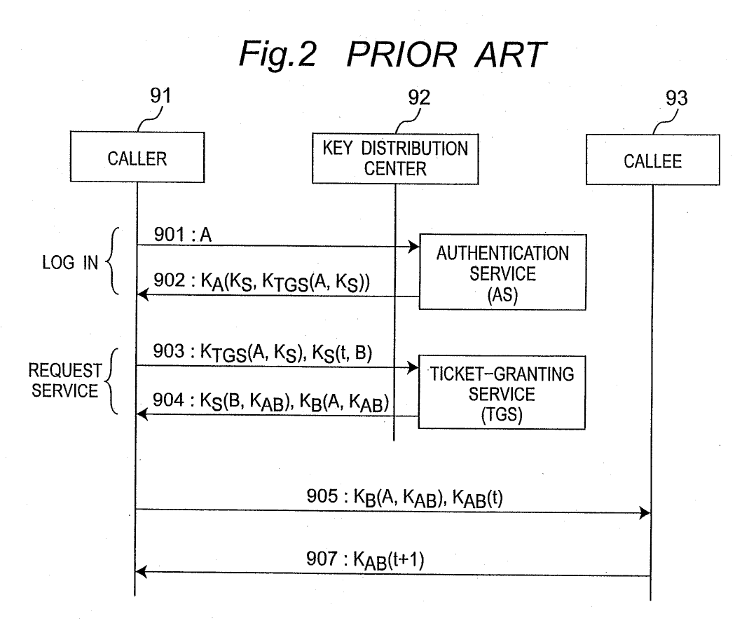

3. The calling facility 100 can submit the first ticket K_{TGS}(A, K_{S}) and the ticket-granting request K_{S}(t,B) to the SIP server 200 for authentication when issuing an INVITE message 501. For the delivery of message subsequent to authentication of the first ticket K_{TGS}(A,K_{S}) and the ticket-granting request K_{S}(t,B), unlike the prior art in which a response is sent back to the caller (as indicated by the direction of delivery of message 904 in FIG. 2), they are directly delivered to the called facility 300, and it is the called facility 300 that proceeds with further authentication actions. Thus, the relevant process steps can be simplified to achieve effects of time-saving and enhanced operating efficiency.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

### INDUSTRIAL APPLICABILITY

The present invention is applicable to an authentication method and apparatus for integrating ticket-granting service into session initiation protocol.

1. An authentication method for integrating ticket-granting service into session initiation protocol, which is adapted to provide session initiation protocol and ticket-granting services between a calling facility and a called facility through a server, the authentication method comprising the following steps:
(A) enabling the calling facility to obtain a first ticket from the server;
(B) enabling the calling facility to issue an INVITE message with the first ticket attached thereto to the server;
(C) enabling the server to examine the registration status of the called facility in the server if the server verifies that the first ticket be issued by the server itself, the flow proceeding to step (D) if the status of the called facility is registered, otherwise the server not providing subsequent ticket-granting service; and
(D) performing identity authentication of both the calling facility and the called facility according to a predetermined ticket authentication procedure so that, if the authentication is successful, the called facility can establish a communication session with the calling facility.

2. The authentication method for integrating ticket-granting service into session initiation protocol according to claim 1, wherein the ticket-granting service has recorded beforehand a caller key (K_{A}) of the calling facility and a callee key (K_{B}) of the called facility, and has recorded the same in the calling facility and called facility, respectively.

3. The authentication method for integrating ticket-granting service into session initiation protocol according to claim 1, wherein, in step (A), the first ticket includes an identification code of the calling facility and a session key (K_{S}), and the first ticket and session key (K_{S}) are encrypted using a caller key (K_{A}) for use by the calling facility.

4. The authentication method for integrating ticket-granting service into session initiation protocol according to claim 3, wherein, in step (B), the INVITE message contains a first timestamp indicating calling time, and in step (D), the predetermined ticket authentication procedure further includes the following steps:
(E) enabling the server to generate a second ticket and a third ticket, attach the second and third tickets to the INVITE message, and send the INVITE message to the called facility;
(F) enabling the called facility to generate called facility authentication data after decrypting the third ticket using a callee key (K_{B}), and deliver a message containing the called facility authentication data and the second ticket to the calling facility through the server;
(G) enabling the calling facility to generate an ACK message containing calling facility authentication data after decrypting the second ticket using a caller key (K_{A}), and deliver the ACK message to the called facility; and
(H) enabling the called facility to establish the communication session with the calling facility after identifying the calling facility authentication data in the ACK message.

5. The authentication method for integrating ticket-granting service into session initiation protocol according to claim 4, wherein, in step (E), the server further generates a communication key (K_{AB}) to be attached to the second ticket and the third ticket for use by the calling facility and the called facility during the communication session.

6. The authentication method for integrating ticket-granting service into session initiation protocol according to claim 5, wherein the second ticket generated by the server includes an identification code of the called facility and the communication key (K_{AB}) which are encrypted by the session key (K_{S}) so as to be used by the calling facility.

7. The authentication method for integrating ticket-granting service into session initiation protocol according to claim 5, wherein the third ticket generated by the server includes an identification code of the calling facility and the communication key (K_{AB}) which are encrypted by the callee key (K_{B}) so as to be used by the called facility.

8. The authentication method for integrating ticket-granting service into session initiation protocol according to claim 5, wherein, in step (F), the called facility authentication data includes the first timestamp encrypted by the communication key (K_{AB}).

9. The authentication method for integrating ticket-granting service into session initiation protocol according to claim 5, wherein, in step (G), the calling facility further generates a second timestamp indicating the time when the called facility can accept a call.

10. The authentication method for integrating ticket-granting service into session initiation protocol according to claim 9, wherein the calling facility authentication data includes the second timestamp encrypted by the communication key (K_{AB}).

11. The authentication method for integrating ticket-granting service into session initiation protocol according to claim 4, wherein, in step (F), the message containing the called facility authentication data and the second ticket is one of a “180 Ringing” message and “200 OK” message.

12. The authentication method for integrating ticket-granting service into session initiation protocol according to claim 1, wherein, in step (B), the calling facility attaches the first ticket to the INVITE message by constructing an additional message header.

13. A server adapted to provide session initiation protocol and ticket-granting services between a calling facility and a called facility, the server comprising:
a server database for storing registration data of users and a first ticket issued to the calling facility beforehand;
a control module for coordinating the operations of various units and having an examining unit for performing relevant examination tasks with respect to received messages, and a determining unit for determining the registration status of the called facility;
a ticket-granting service module for providing ticket-granting service and performing relevant ticket processing tasks;
a session initiation protocol unit for providing session initiation protocol service, and cooperating with the ticket-granting service module to process the data into messages with formats complying with the session initiation protocol; and
a communication interface acting as an interface to communicate with other devices, and used to transmit messages processed by the session initiation protocol unit to the other devices and to receive outside messages.

14. The server according to claim 13, wherein the server database stores both a caller key (K_{A}) of the calling facility and a callee key (K_{B}) of the called facility beforehand, which are recorded in the calling facility and called facility, respectively.

15. The server according to claim 13, wherein, the examining unit of the control module examines the outside messages received by the communication interface so that, if the examining unit verifies that an INVITE message contains the first ticket stored in the server database attached thereto, the determining unit determines the registration status of the called facility in the server database to the effect that if the status of the called facility is registered, the ticket-granting service module provides subsequent ticket-granting service, and otherwise, the ticket-granting service module does not provide the subsequent ticket-granting service.

16. The server according to claim 15, wherein the first ticket stored in the server database and issued to the calling facility beforehand includes an identification code of the calling facility and a session key (K_{S}).

17. The server according to claim 16, wherein the ticket-granting service module further includes a generating unit for generating tickets, the generating unit generating a second ticket corresponding to the calling facility and a third ticket corresponding to the called facility when the determining unit determines the registration status of the called facility in the server database to be registered, the session initiation protocol unit cooperating with the ticket-granting service module to process the tickets to be compliant with the session initiation protocol, attach the tickets to the INVITE message, and send the INVITE message to the called facility through the communication interface.

18. The server according to claim 17, wherein the generating unit further generates a communication key (K_{AB}), which is attached to the second ticket and the third ticket for use by the calling facility and the called facility during a communication session.

19. The server according to claim 18, wherein the second ticket includes an identification code of the called facility and the communication key (K_{AB}), which are encrypted by a session key (K_{S}), to be used by the calling facility.

20. The server according to claim 18, wherein the third ticket includes an identification code of the calling facility and the communication key (K_{AB}), which are encrypted by the callee key (K_{B}), to be used by the called facility.

21. A calling facility adapted to receive session initiation protocol and ticket-granting services provided by a server so as to conduct a communication session with a called facility, the server being capable of issuing a first ticket to the calling facility, the calling facility comprising:
a user interface for input of data by a user;
a client database for storing the first ticket and a caller key (K_{A});
a control module for coordinating the operations of various units;
a ticket-granting service module for providing the ticket-granting service and performing relevant ticket processing tasks;
a session initiation protocol unit for providing session initiation protocol service and cooperating with the ticket-granting service module to process data into messages with formats complying with the session initiation protocol; and
a communication interface acting as an interface to communicate with other devices, and used to transmit messages processed by the session initiation protocol unit to the other devices and to receive outside messages.

22. The calling facility according to claim 21, wherein the caller key (K_{A}) stored in the client database is also recorded in the server and is used by the server to encrypt the first ticket.

23. The calling facility according to claim 21, wherein the first ticket from the server as stored in the client database includes an identification code of the calling facility and a session key (K_{S}).

24. The calling facility according to claim 23, wherein, when intending to conduct the communication session with the called facility, the ticket-granting service module retrieves the first ticket from the client database, the session initiation protocol unit cooperating with the ticket-granting service module to deliver an INVITE message containing the first ticket attached thereto to the server via the communication interface, the server generating a communication key (K_{AB}) based thereon, attaching the communication key (K_{AB}) to a second ticket and a third ticket, sending the second and third tickets to the called facility, and receiving an authentication message sent back from the called facility, the communication session between the calling facility and the called facility being subsequently established according to the authentication message; the control module includes an examining unit for performing relevant examination tasks on the outside messages received from the communication interface, and for examining whether called facility authentication data generated by the called facility and the second ticket are contained in any of the outside messages.

25. The calling facility according to claim 24, wherein the ticket-granting service module includes a generating unit for generating tickets, the generating unit generating calling facility authentication data when the examining unit finds that the called facility authentication data generated by the called facility and the second ticket are contained in the outside message, and the ticket-granting service module decrypts the second ticket using the session key (K_{S}) so as to obtain a communication key (K_{AB}), the session initiation protocol unit processing the calling facility authentication data into an ACK message complying with the session initiation protocol, and delivering the ACK message to the called facility through the communication interface.

26. The calling facility according to claim 25, wherein the generating unit encrypts a second timestamp using the communication key (K_{AB}) to generate the calling facility authentication data.

27. The calling facility according to claim 26, wherein the session initiation protocol unit further indicates in the ACK message the second timestamp as the time when the called facility can accept a call.

28. The calling facility according to claim 21, wherein the session initiation protocol unit attaches the first ticket to the INVITE message by constructing an additional message header, and indicates a first timestamp as the calling time in the INVITE message.

29. A called facility adapted for receiving session initiation protocol and ticket-granting services provided by a server so as to conduct a communication session with a calling facility, the called facility comprising:
a user interface for input of data by a user;
a client database for storing a callee key (K_{B}) of the called facility;
a control module for coordinating the operations of various units;
a ticket-granting service module for providing the ticket-granting service and performing relevant ticket processing tasks, the ticket-granting service module including an identifying unit for identifying received tickets;
a session initiation protocol unit for providing session initiation protocol service and cooperating with the ticket-granting service module to process data into messages with formats complying with the session initiation protocol; and
a communication interface acting as an interface to communicate with other devices, and used to transmit messages processed by the session initiation protocol unit to the other devices and to receive outside messages.

30. The called facility according to claim 29, wherein the callee key (K_{B}) stored in the client database is also recorded in the server, and is used by the server to encrypt the third ticket.

31. The called facility according to claim 29, wherein, an examining unit of the control module is responsible for examining whether any of the outside messages received by the communication interface contains a second ticket and a third ticket generated by the server, and if the second and third tickets are available, the ticket-granting service module delivers a reply message containing the second ticket to the calling facility so as to receive an ACK message from the calling facility and to establish a communication session with the calling facility according to the ACK message.

32. The called facility according to claim 31, wherein the ticket-granting service module further includes a generating unit for generating tickets, the generating unit generating called facility authentication data when an examining unit of the control module finds that an outside message contains a second ticket and a third ticket, and the identifying unit of the ticket-granting service module uses the callee key (K_{B}) obtained from the client database to decrypt the third ticket in the outside message so as to obtain a communication key (K_{AB}), the session initiation protocol unit processing the called facility authentication data and the second ticket into a message with format complying with the session initiation protocol, and delivering the same to the server through the communication interface.

33. The called facility according to claim 32, wherein the generating unit generates the called facility authentication data by encrypting a first timestamp using the communication key (K_{AB}).

34. The called facility according to claim 32, wherein the session initiation protocol unit processes the called facility authentication data and the data of the second ticket into one of a “180 Ringing” message and a “200 OK” message.
